(19) United States
(12) Patent Application Publication
(10) Pub. No.: US 2005/0134557 A1
(43) Pub. Date: Jun. 23, 2005

(54) ACF assembly apparatus and method

(76) Inventors: Xu-Wen Feng, Suchou City (CN); Ching-Yun Chen, Suchou City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/741,975

(22) Filed: Dec. 19, 2003

(51) Int. Cl. G09G 5/00

(52) U.S. Cl. 345/156

(57) ABSTRACT

An ACF assembly apparatus for a display panel and an assembly method thereof. The ACF assembly method includes the following steps. An adhesive member with an ACF and a separator is first provided. The adhesive member is then attached to the display panel. The separator is removed from the adhesive member attached to the display panel while the ACF remained on the display panel is detected by a moveable sensor.

### BACKGROUND OF THE INVENTION

1. Field of the Invention

The invention relates to an ACF (anisotropic conductive film) assembly apparatus and method, and in particular, to an ACF assembly method that ensures precise and reliable connection with a display panel.

2. Description of the Related Art

In recent years, a display panel, such as a liquid crystal display (LCD) panel, has been widely used instead of CRT.

The display panel has a display layer for performing display. The display layer is held between a pair of substrates, or is carried or held by a single substrate. In the liquid crystal display panel, the display layer is a liquid crystal layer, and is held between a pair of substrates.

In the display panel, transparent electrodes are formed on opposite sides of the display layer for changing the state of the display layer to perform display. For example, a voltage is applied across the electrodes to change the state of the display layer, so that the display is performed.

The electrode on at least one side is usually formed on the substrate provided for holding or carrying the display layer. The electrode on the substrate is usually electrically connected to a drive element (e.g., drive IC) of a drive device, and a control portion of the drive device applies a voltage via the drive element to the electrode for driving the display panel.

The drive element is mounted directly on the substrate of the display panel, and is usually directly connected to the electrode on the substrate. Specifically, a lead of the drive element may be connected to the electrode with an anisotropic conductive adhesive such as ACF while applying a heat and a pressure during the connecting operation.

Before the ACF is attached on the display panel, it is combined with a separator to form an adhesive member. The specific description of the conventional ACF assembly method is described in the following.

Referring to FIG. 1A, a conventional ACF assembly apparatus 10 for a display panel 20 is described. The conventional ACF assembly apparatus 10 includes a press head 11, a pair of first rollers 12, a pair of second rollers 13, a pair of third rollers 14, a supply 15, a recycling device 16, and three sensors 17.

The press head 11 is located above the adhesive member 30, and applies the pressure to the adhesive member 30 during the connecting operation. Referring to FIG. 1B, the adhesive member 30 includes ACF 31 and a separator 32.

The adhesive member 30 passes between the first rollers 12 so that the separator 32 can be separated from the ACF 31 by the first rollers 12. The second rollers 13 and the third rollers 14 guide the adhesive member 30 to move along a predetermined path. It is noted that the first rollers 12 and the second rollers 13 can move upward or downward during the connecting operation. The supply 15 provides the adhesive member 30, and the recycling device 16 can hold and recycle the separated separator 32.

The sensors 17 are fixedly located above an electrode area 21 of the display panel 20, and detects whether or not the ACF 31 is precisely attached to the electrode area 21.

To assemble the ACF 31 on the electrode area 21, the adhesive member 30 is first aligned with the electrode area 21 of the display panel 20. The press head 11, the first rollers 12, and the second rollers 13 along with the adhesive member 30 then move downward, and the press head 11 applies the pressure to the adhesive member 30 on the electrode area 21 so that the adhesive member 30 is attached to the electrode area 21. The first rollers 12 moves to the left side from the right side, so as to separate the separator 32 from the ACF 31 remained on the display panel 20. The first rollers 12 and the second rollers 13 then move upward, and the separated separator 32 is recycled by the recycling device 16. The ACF 31 remained on display panel 20 is then detected by the fixed sensors 17. If the ACF attachment fails due to the breakage of the ACF or others, the alarm is triggered and the assembly process halted.

It is understood that the display panel 20 includes two electrode areas 21 at two sides of the display panel 20 as shown in FIG. 1A. Thus, the ACF assembly process may be performed twice on one display panel 20.

The conventional ACF assembly method has the following disadvantage. As shown in FIG. 1C, since the sensors 17 are fixed at a predetermined location, only specific areas A on the display panel 20 can be detected by the sensors 17. Thus, other areas B cannot be detected by the sensors 17. As a result, the entire ACF cannot be detected, and the yield of the display panel is accordingly reduced. Moreover, the cost due to rework is increased.

### SUMMARY OF THE INVENTION

In view of this, the present invention provides an ACF assembly method and apparatus that ensures precise and reliable connection with a display panel.

Accordingly, the present invention provides an ACF assembly apparatus for a display panel. The ACF assembly apparatus includes a pressing device, a separating device, and a sensor. The pressing device attaches an adhesive member onto the display panel. The adhesive member includes ACF and a separator. The separating device is moveable relative to the display panel, and removes the separator from the ACF remained on the display panel. The sensor is disposed on the separating device and moves along with the separating device, and detects the ACF on the display panel.

In a preferred embodiment, the ACF assembly apparatus further includes a recycling device, a plurality of rollers, a controller, and a supply. The recycling device holds and recycles the removed separator. The rollers guide the adhesive member to move along a predetermined path. The controller is coupled to the sensor, and receives a signal from the sensor. The supply provides the adhesive member.

Furthermore, the pressing device is a press head. The separating device includes two rollers.

In the present invention, an ACF assembly method for a display panel is provided. The ACF assembly method includes the following steps. An adhesive member with ACF and a separator is provided. The adhesive member is then attached to the display panel. The separator is removed from the display panel while the ACF remained on the display panel is detected.

It is noted that the entire ACF on the display panel can be detected by a moveable sensor.

In another embodiment, the adhesive member is attached to the display panel by pressing. The separator is separated from the display panel by rollers.

### BRIEF DESCRIPTION OF THE DRAWINGS

The present invention can be more fully understood by reading the subsequent detailed description and examples with references made to the accompanying drawings, wherein:

FIG. 1A is a schematic view of a conventional ACF assembly apparatus;

FIG. 1B is a partial enlarged view of an adhesive member in FIG. 1A;

FIG. 1C is a schematic view showing the relationship between a display panel and sensors in FIG. 1A;

FIG. 2A is a schematic view of an ACF assembly apparatus as disclosed in the invention;

FIG. 2B is a schematic view showing the relationship between a display panel and sensors in FIG. 2A; and

FIG. 3 is a flowchart of an ACF assembly method as disclosed in the invention.

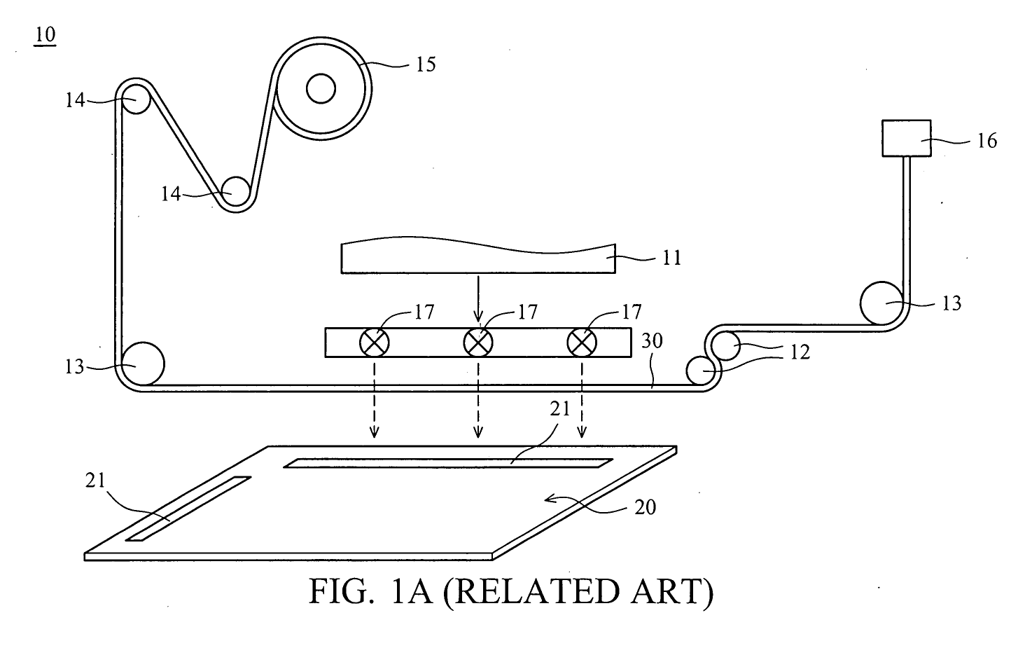

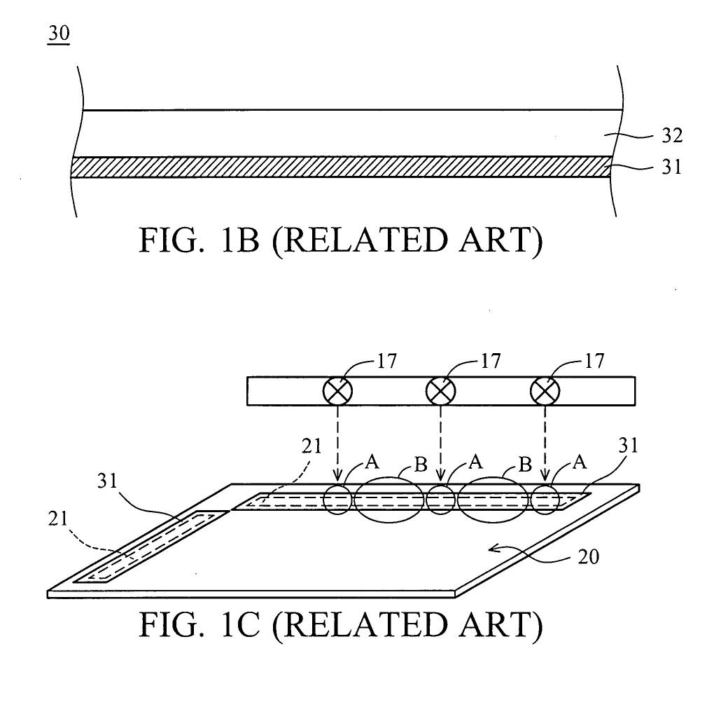

### DETAILED DESCRIPTION OF THE INVENTION

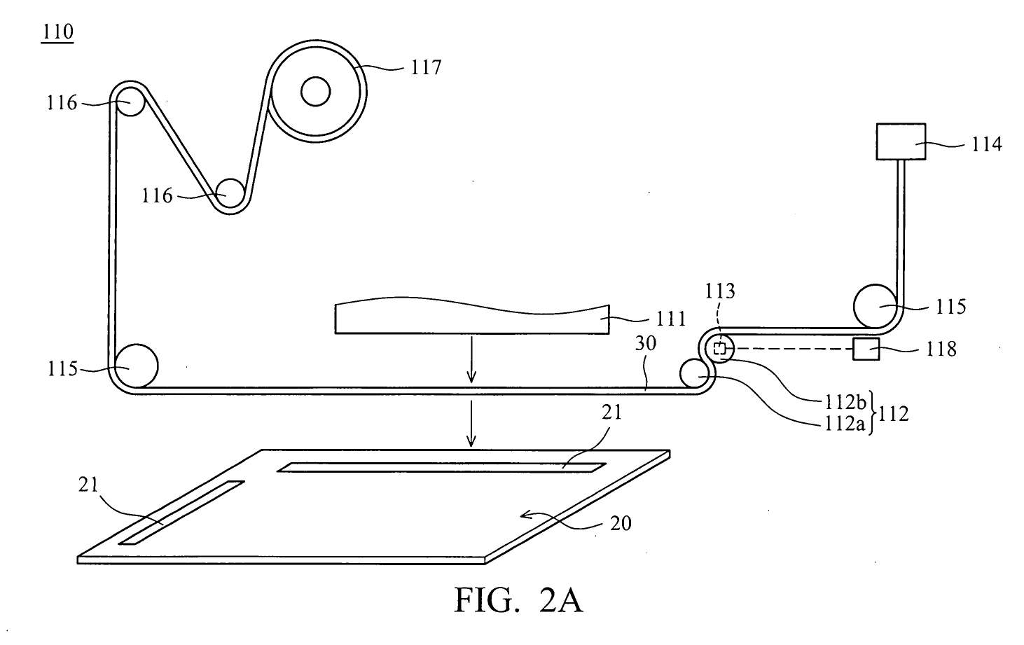

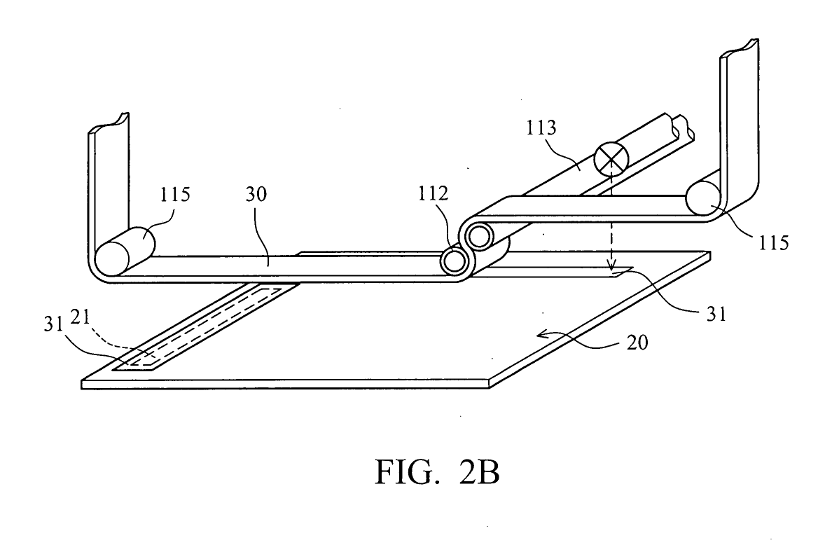

Referring to FIGS. 2A-2B, an ACF assembly apparatus 110 as disclosed in the invention is shown. The ACF 10 assembly apparatus 110 serves to attach an adhesive member 30 onto a display panel 20, and includes a pressing device 111, a separating device 112, a sensor 113, a recycling device 114, a pair of first rollers 115, a pair of second rollers 116, a supply 117, and a controller 118.

The pressing device 111 is located above the adhesive member 30, and applies the pressure to the adhesive member 30 during assembly so as to attach the adhesive member 30 onto the display panel 20. The pressing device 111 may be a press head.

The separating device 112 is moveable relative to the display panel 20, and includes two rollers 112a, 112b. The adhesive member 30 passes between the rollers 112a, 112b so that the separator 32 can be separated from the ACF 31 by the rollers 112a, 112b of the separating device 112.

As shown in FIG. 2B, the sensor 113 is disposed on the separating device 112, and is moved along with the separating device 112. The sensor 113 can detect whether or not the ACF 31 is precisely attached to the electrode area 21 of the display panel 20 while the separator 32 is separated by the separating device 112.

The recycling device 114 can hold and recycle the removed separator 32. The first rollers 115 and the second rollers 116 guide the adhesive member 30 to move along a predetermined path. It is noted that the separating device 112 and the first rollers 115 can move upward or downward during assembly.

The supply 117 provides the adhesive member 30. The controller 118 is coupled to the sensor 113, and receives a signal from the sensor 113. If an abnormal situation is detected by the sensor 113, the controller 118 will receive a fail signal from the sensor 113 and halt the assembly process after the separator 32 is separated entirely from the ACF 31 that attached on the display panel 20.

The structure of the ACF assembly apparatus is described as above, and the ACF assembly method thereof is described in the following.

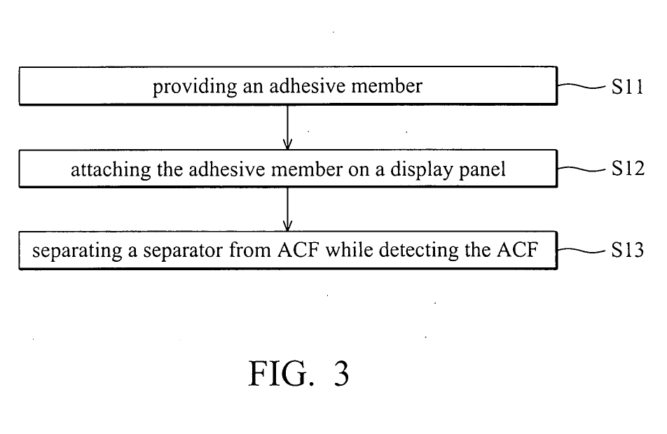

Referring to FIG. 3, in step S11, the adhesive member 30 is provided, and is aligned with the electrode area 21 of the display panel 20. The pressing device 111, the separating device 112, and the first rollers 115 along with the adhesive member 30 then move downward. The pressing device 111 applies the pressure to the adhesive member 30 on the electrode area 21 so that the adhesive member 30 is attached to the electrode area 21 in step S12. In step S13, the separating device 112 moves to the left side from the right side so as to separate the separator 32 from the ACF 31 remained on the display panel 20. At the same time, the sensor 113, moving along with the separating device 112, detects whether or not the ACF 31 is precisely attached to the electrode area 21 of the display panel 20. If the ACF attachment is failed due to the breakage of the ACF or others, the sensor 113 will transmit a signal to the controller 118 so as to trigger the alarm and halt the assembly process after the separator 32 is separated entirely from the ACF 31 that attached on the display panel 20. The separating device 112 and the first rollers 115 finally move upward, and the removed separator 32 is recycled by the recycling device 114.

As stated above, by means of the moveable sensor, the entire ACF on the display panel can be detected. Thus, the yield can be enhanced.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An ACF assembly apparatus for a display panel comprising:
a pressing device for attaching an adhesive member onto the display panel, wherein the adhesive member includes ACF and a separator;
a separating device, moveable relative to the display panel, for removing the separator from the adhesive member attached to the display panel; and
a sensor, disposed on the separating device and moved along with the separating device, for detecting the ACF on the display panel.

2. The ACF assembly apparatus as claimed in claim 1, further comprising:
a recycling device for holding and recycling the removed separator.

3. The ACF assembly apparatus as claimed in claim 1, further comprising:
a plurality of rollers for guiding the adhesive member to move along a predetermined path.

4. The ACF assembly apparatus as claimed in claim 1, wherein the pressing device is a press head.

5. The ACF assembly apparatus as claimed in claim 1, wherein the separating device includes two rollers.

6. The ACF assembly apparatus as claimed in claim 1, further comprising:
a controller, coupled to the sensor, for receiving a signal from the sensor.

7. The ACF assembly apparatus as claimed in claim 1, further comprising:
a supply for providing the adhesive member.

8. An ACF assembly method for a display panel comprising:
providing an adhesive member with ACF and a separator;
attaching the adhesive member to the display panel; and
removing the separator from the display panel while detecting the ACF remained on the display panel.

9. The ACF assembly method as claimed in claim 8, wherein the entire ACF on the display panel is detected while the separator is removed from the display panel.

10. The ACF assembly method as claimed in claim 8, wherein the ACF is detected by a moveable sensor.

11. The ACF assembly method as claimed in claim 8, wherein the adhesive member is attached to the display panel by pressing.

12. The ACF assembly method as claimed in claim 8, wherein the separator is separated from the display panel by rollers.

13. The ACF assembly method as claimed in claim 8, wherein the separator is removed by a recycling device.

14. The ACF assembly method as claimed in claim 8, wherein the adhesive member is provided by a supply.
